(19) United States
(12) Patent Application Publication
(10) Pub. No.: US 2017/0122499 A1
(43) Pub. Date: May 4, 2017

(54) LIGHT EMITTING DIODE LAMP

(71) Applicant: ADVANCED OPTOELECTRONIC TECHNOLOGY, INC., Hsinchu Hsien 303 (TW)

(72) Inventors: Hao-Xiang LIN, Hukou (TW); Cheng-Chun LIAO, Hukou (TW); Yuan-Ching CHEN, Hukou (TW)

(21) Appl. No.: 14/985,402

(22) Filed: Dec. 31, 2015

(30) Foreign Application Priority Data
Oct. 29, 2015 (CN) 201510715031.X

(51) Int. Cl. F21K 99/00; F21V 29/50; F21V 23/00

(52) U.S. Cl. CPC F21K 9/1355; F21V 23/003; F21K 9/50; F21V 29/50

(57) ABSTRACT

An LED (light emitting diode) lamp, includes a lamp holder, a connection portion connected with the lamp holder, a lampshade mounted on the connection portion to define a first cavity with the connection portion and the lamp holder, a plurality of filaments are located in the first cavity, and a supporting pillar connected with the lamp holder and a plurality of wire frames, the filaments are spaced from each other and are configured around the supporting pillar. Each of the filaments and the supporting pillar are configured at different planes, and each filament are configured in different planes, and the filaments are coupled with the lamp holder by the wire frames to emit light.

### CROSS-REFERENCE TO RELATED APPLICATIONS

This application claims priority to Chinese Patent Application No. 201510715031.X filed on Oct. 29, 2015, the contents of which are incorporated by reference herein.

### FIELD

The subject matter herein generally relates to a lamp, especially relates to a light emitting diode lamp.

### BACKGROUND

A light emitting diode (LED) lamp includes a base, a heat dissipation portion connected to the base, a circuit board mounted on the heat dissipation portion and a plurality of LEDs located on and coupled with the circuit.

### BRIEF DESCRIPTION OF THE DRAWINGS

Implementations of the present technology will now be described, by way of example only, with reference to the attached figures.

FIG. 1 is an assembled isometric view of an LED lamp of the present disclosure.

FIG. 2 is an exploded view of the LED lamp of FIG. 1.

FIG. 3 is a partial isometric view of the LED lamp of FIG. 2.

FIGS. 4-7 are diagrammatic diagrams of a light intensity distribution of the LED lamp of FIG. 1.

### DETAILED DESCRIPTION OF EMBODIMENTS

It will be appreciated that for simplicity and clarity of illustration, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts have been exaggerated to better illustrate details and features of the present disclosure. The description is not to be considered as limiting the scope of the embodiments described herein.

Several definitions that apply throughout this disclosure will now be presented. The term “comprising” means “including, but not necessarily limited to”; it specifically indicates open-ended inclusion or membership in a so-described combination, group, series and the like. The term “coupled” is defined as connected, whether directly or indirectly through intervening components, and is not necessarily limited to physical connections. The connection can be such that the objects are permanently connected or releasably connected.

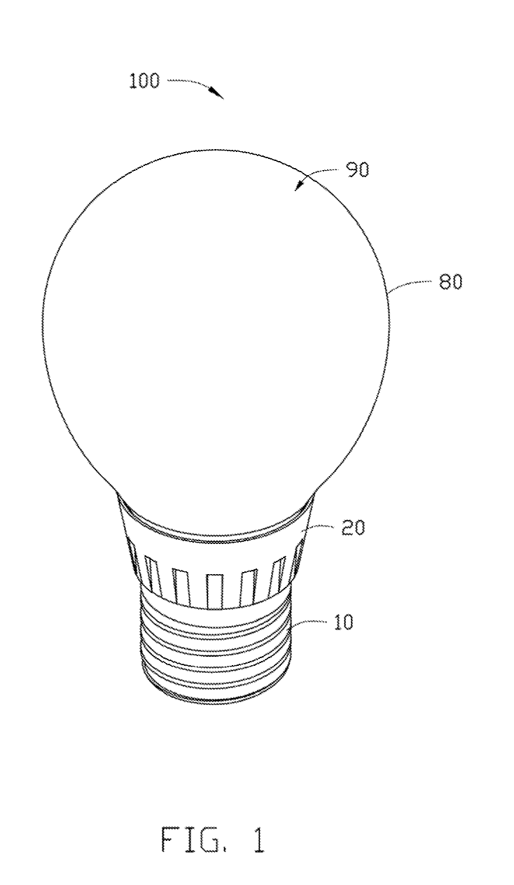

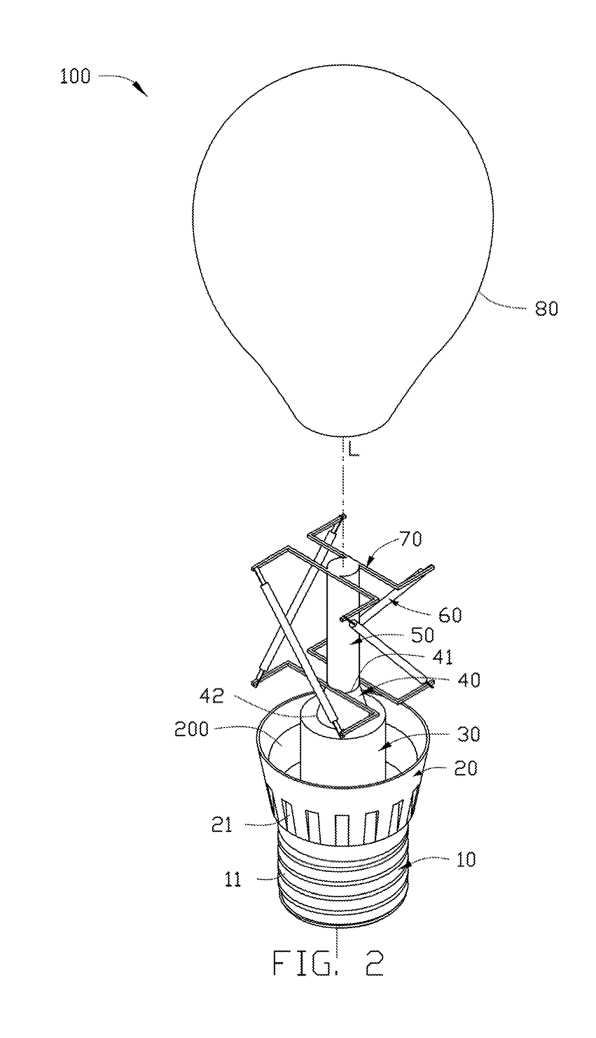

As illustrated in FIGS. 1-2, an LED lamp 100 of the present disclosure includes a lamp holder 10, a connection portion 20 connected with the lamp holder 10 and a lampshade 80 mounted on the connection portion 20. The connection portion 20 and the lampshade 80 define a first cavity 90. A driver 30, a connecting base 40, a supporting pillar 50, a plurality of filaments 60 and a plurality of wire frames 70 are received in the first cavity 90.

The LED lamp 100 has an axis L. The lamp holder 10, the connection portion 20, the driver 30, the connecting base 40, the supporting pillar 50 and the lampshade 80 are symmetrical about the axis L.

The lamp holder 10 is made of mental material. The lamp holder 10 is substantially cylinder-shaped. An outer surface of the lamp holder 10 forms a plurality of screw threads 11 for coupling the lamp holder 10 with a socket of power.

The connection portion 20 can be made of plastic. The connection portion 20 is substantially cone-shaped and has a second cavity 200. An outer diameter of the connection portion 20 increases from an end connected with the lamp holder 10 to another end connected with the lampshade 80 thereof. An outer surface of the connection portion 20 defines a plurality of grooves 21 along the circumferential direction for improving cooling efficiency of the connection portion 20. Widths of the grooves 21 are equal and depths of the grooves 21 increases from the end connecting with the connection portion 20 to the other end thereof. An interval spaced between each two adjacent grooves 21 is coincident.

The driver 30 is substantially cylinder-shaped. The driver 30 is received in the second cavity 200 to couple with the lamp holder 10.

The connecting base 40 located at a top center of the driver 30. The connecting base 40 is cone-shaped. The connecting base 40 has a bottom surface 42 coupled with the driver 30 and a top surface 41 located opposite to the bottom surface 42. A diameter of the bottom surface 42 is larger than that of the top surface 41 of the connecting base 40. A diameter of the connecting base 40 decreases gradually from the bottom surface 42 to the top surface 41. The bottom surface 42 is coupled with the driver 30 and the top surface 41 is coupled with the wire frames 70 and the filaments 60.

The supporting pillar 50 is substantially cylinder-shaped and is located on the top surface 41 of the connecting base 40. An outer diameter of the supporting pillar 50 is equal to the diameter of the top surface 41 of the connecting base 40. The supporting pillar 50 can be made of insulation material. In the illustrated embodiment, the supporting pillar 50 is made of glass material. The supporting pillar 50 is configured to fix the wire frames 70 thereon.

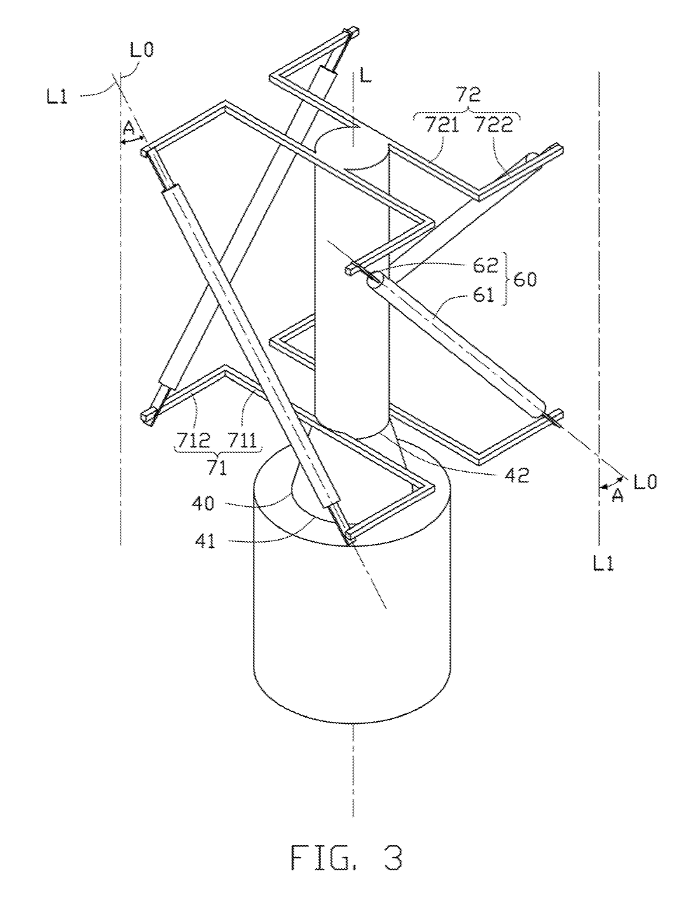

As illustrated in FIG. 3, the filaments 60 are elongated tubular shape. Each of the filaments 60 includes a wick 61 and two electrode 62 extended from two ends of the wick 61 and coupled with the wick 61. Each wick 61 includes a plurality of LEDs coupled to each other in series connection or parallel connection. A number and a color of each LED can be configured according to a actually demand. The filaments 60 are coupled with the wires frames 70 through the electrodes 62 and are coupled with the driver 30 by the wire frames 70.

The filaments 60 surround the supporting pillar 50 and are spaced from the supporting pillar 50. The filaments 60 are spaced from each other and are interlaced each other. Each two of the filaments 60 and the supporting pillar 50 are configured in different planes. Thus, each filament 60 and the supporting pillar 50 define a space angle. Specifically and hypothetically, if moving the supporting pillar 50 in parallel to intersect one of the filament 60 in the same plane, the supporting pillar 50 and the filament 60 define an angle A. The angle A is in a range of 30° and 50°. The angle A defined between each filament 60 and the supporting pillar 50 can be the same. It can be understood that the angle A defined between each filament 60 and the supporting pillar 50 differ from each other.

Also as illustrated in FIG. 3, the number of the filaments 60 is four, each filament 60 and the supporting pillar 50 define the angle A. Generally, each filament 60 has an axis L1. Define an imaginary axis L0 parallel with the axis L and define the imaginary axis L0 configured at the same plane with the axis L1. Thus, the axis L1 and the axis L0 define the angle A. The angle A is in a range of 30° and 50°.

The wire frames 70 are respectively located at and coupled with two ends of the supporting pillar 50. The wire frames 70 include a plurality of first wire frames 71 and a plurality of second frames 72. The first wire frames 71 are coupled with bottom edges of the supporting pillar 50 and connected with the top surface 41 of the connecting base 40. The second frames 72 are coupled with top edges of the supporting pillar 50.

In the illustrated embodiment, the number of the first wire frames 71 is two. The two first wire frames 71 are symmetrical about the supporting pillar 50. The number of the second wire frames 72 is two. The two second wire frames 72 are also symmetrical about the supporting pillar 50. Each first wire frame 71 includes a main portion 711 and two extending portion 712 extending vertically from two ends of the main portion 711. The extending portions 712 extend towards the same direction. Accordingly, each second wire frame 72 includes a main portion 721 and two extending portion 722 extending vertically from two ends of the main portion 721. The extending portions 722 of the each second wire frame 72 extend towards the same direction. The main portions 711 and the extending portions 712 of the first wire frames 71 is correspondingly parallel with the main portions 721 and the extending portions 722 of the second wire frames 72.

The filaments 60 are configured correspondingly between the first wire frames 71 and the second wire frames 72. The electrode 62 of each filament 60 couples with the extending portions 712 of the first frames 71 and the extending portions 722 of the second frames 72 respectively. Specifically, one electrode 61 of each filament 60 couples with one extending portion 721 of the second wire frame 72, and another electrode 62 couples with the extending portion 712 of the first frame 71 located diagonally at the extending portion 721 of the second wire frame 72. Thus, the filaments 60 and the supporting pillar 50 are configured crisscross in space.

The lampshade 80 locates on the connection portion 20 and covers components except the lamp holder 10 and connection portion 20 of the LED lamp 100. The lampshade 80 is made of heat dissipation material. The lampshade 80 can refract light to increase the emitting angle of the LED lamp 100. In the illustrated embodiment, the lampshade 80 and the connection portion 20 define a vacuum sealed cavity. The vacuum sealed cavity can be filled with thermal conductive gaps for heat dissipation. The thermal conductive gaps can be Helium, hydrogen, or Helium mixed with hydrogen.

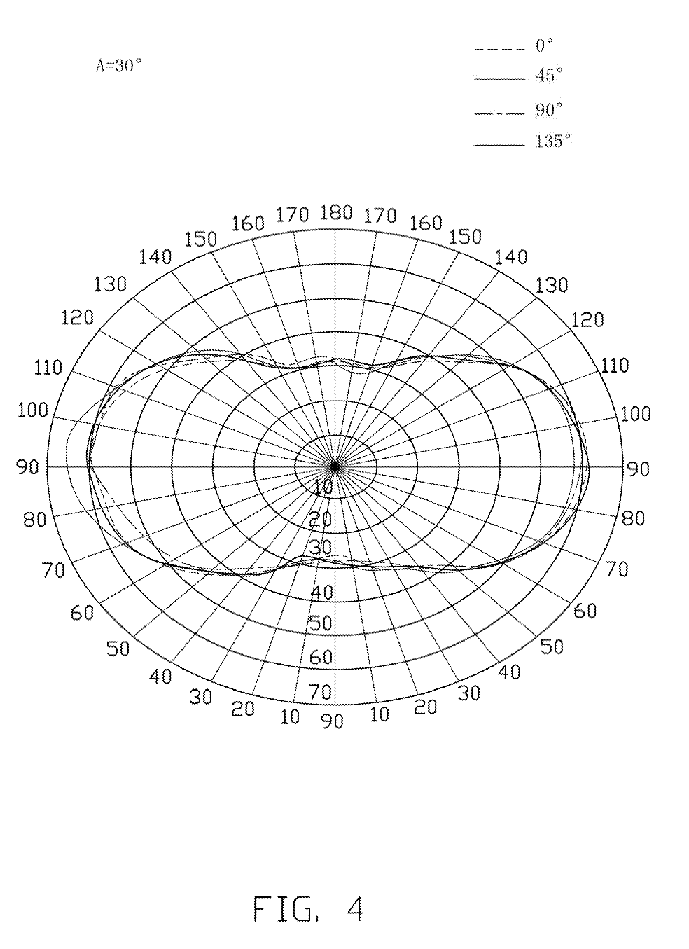

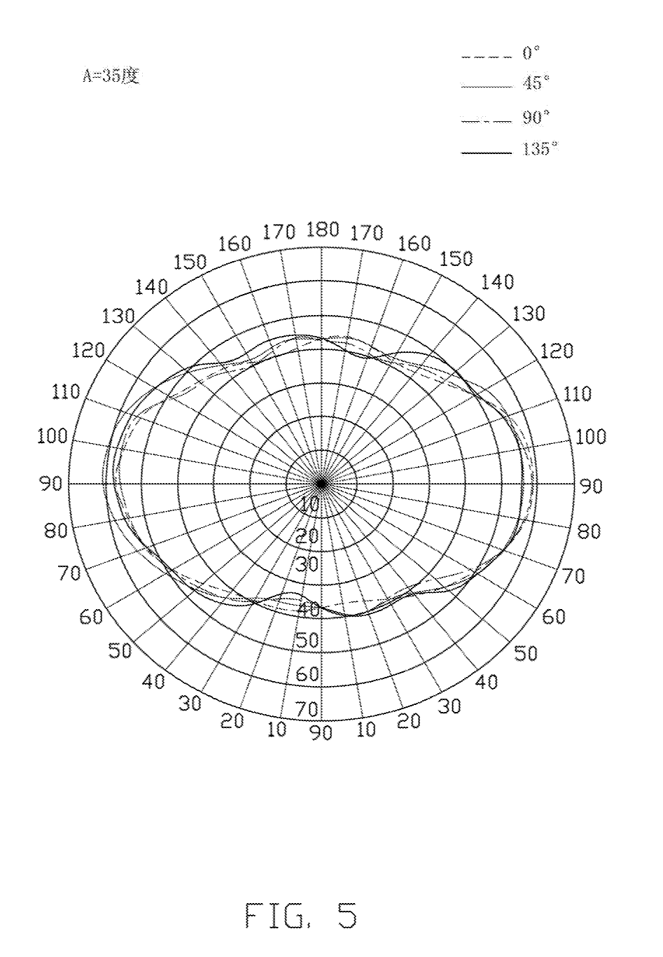

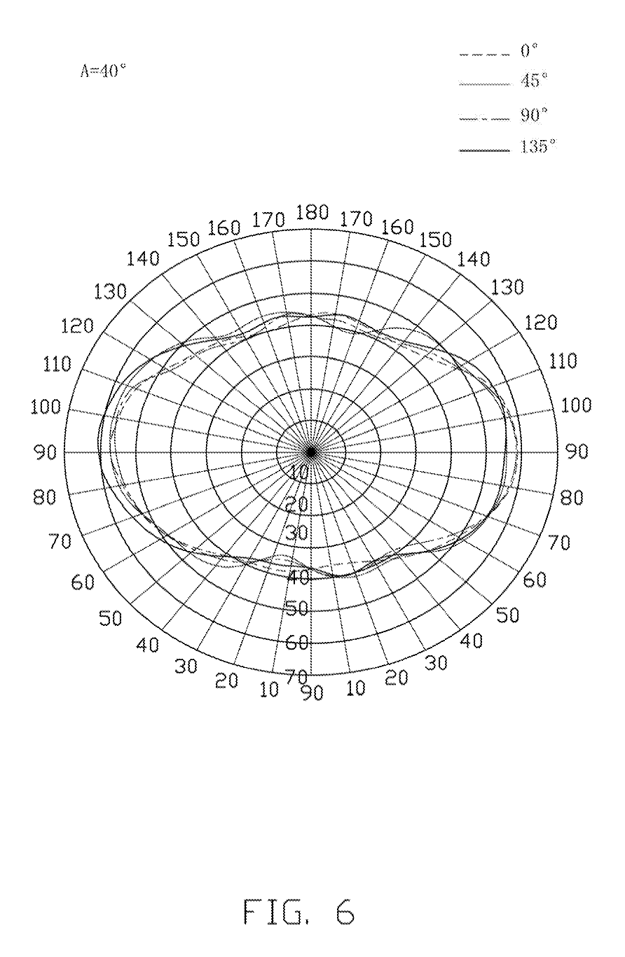

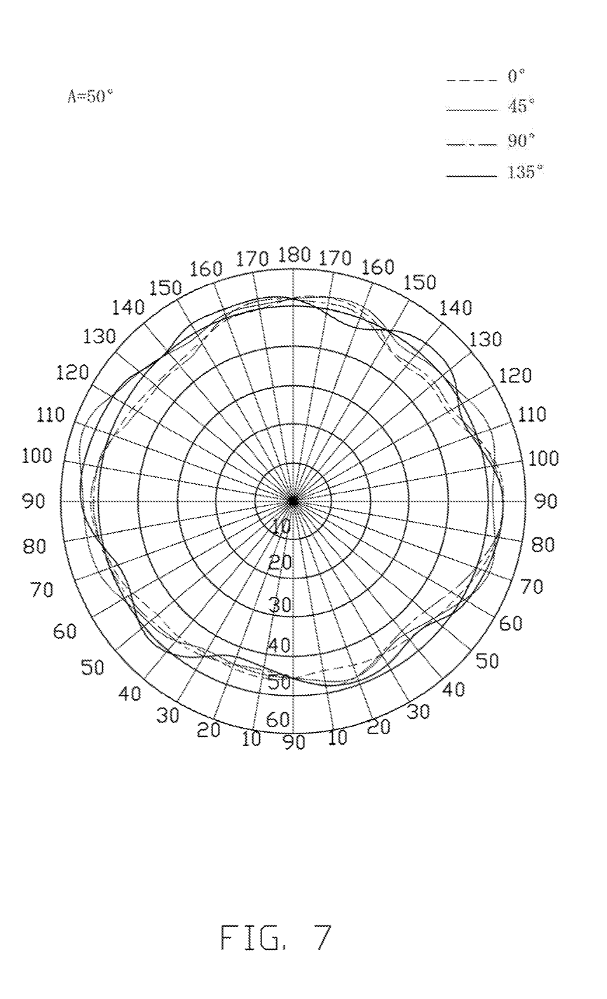

FIGS. 4-7 respectively illustrates a light intensity of the LED lamp 100, while the angle A defined between the supporting pillar 50 and the filaments 60 respectively is 30°, 35°, 40° and 50°. In each FIGS. 4-7, a line corresponding to 0° shows a light intensity along the axis L of the LED lamp 100; a line corresponding to 45° shows a light intensity of an angle defined between the axis L and an outer periphery of the LED lamp 100; a line corresponding 90° shows a light intensity of the an angle defined between the axis L and an outer periphery of the LED lamp 100; a line corresponding 135° shows a light intensity of an angle defined between the axis L and an outer periphery of the LED lamp 100. Thus, the LED lamp has large emitting angle and uniform light intensity at a direction of the axis L and the outer periphery thereof.

The embodiments shown and described above are only examples. Many details are often found in the art such as the other features of an LED lamp. Therefore, many such details are neither shown nor described. Even though numerous characteristics and advantages of the present technology have been set forth in the foregoing description, together with details of the structure and function of the present disclosure, the disclosure is illustrative only, and changes can be made in the detail, including in matters of shape, size and arrangement of the parts within the principles of the present disclosure up to, and including the full extent established by the broad general meaning of the terms used in the claims. It will therefore be appreciated that the embodiments described above can be modified within the scope of the claims.

What is claimed is:

1. A light emitting diode (LED) lamp, comprising:
a lamp holder;
a connection portion connected with the lamp holder;
a lampshade mounted on the connection portion and configured to define a first cavity with the connection portion and the lamp holder;
a plurality of filaments located in the first cavity; and
a supporting pillar connected with the lamp holder and a plurality of wire frames, the plurality of filaments being spaced from each other and being configured around the supporting pillar, each of the plurality of filaments and the supporting pillar being configured at different planes, and each filament being configured in different planes, and the plurality of filaments being coupled with the lamp holder by the wire frames to emit light.

2. The LED lamp of claim 1, wherein each filament and the supporting pillar define a space angle, and the angle is in a range of 30° and 50°.

3. The LED lamp of claim 2, wherein the angles defined between each filament and the supporting pillar are the same.

4. The LED lamp of claim 2, wherein the angles defined between each filament and the supporting pillar are different from each other.

5. The LED lamp of claim 2, wherein the wire frames are respectively located at and coupled with two ends of the supporting pillar.

6. The LED lamp of claim 5, wherein each of the wire frames comprises a plurality of first wire frames and a plurality of second frames.

7. The LED lamp of claim 6, wherein the first wire frames couple with bottom edges of the supporting pillar, and the second frames couple with top edges of the supporting pillar.

8. The LED lamp of claim 6, wherein the first wire frames are configured symmetrically about the supporting pillar, the second wire frames are also configured symmetrically about the supporting pillar.

9. The LED lamp of claim 6, wherein each of the first wire frames comprises a main portion and two extending portion extending vertically from two ends of the main portion, and each of the second wire frames comprises a main portion and two extending portion extending vertically from two ends of the main portion.

10. The LED lamp of claim 9, wherein the extending portions of the first wire frames extend towards the same direction, and the extending portions of the second wires frames extend towards the same direction.

11. The LED lamp of claim 9, wherein one electrode of each filament couples with one extending portion of the second wire frame, and another electrode couples with the extending portion of the first frame located diagonally at the extending portion of the second wire frame.

12. The LED lamp of claim 2, wherein the filaments are elongated tubular, each of the filaments comprises a wick and two electrodes extended from two ends of the wick and coupled with the wick.

13. The LED lamp of claim 12, wherein each of the wicks comprises a plurality of LEDs coupled to each other in series connection or parallel connection.

14. The LED lamp of claim 1, further comprising a driver and a connecting base mounted on and coupled with the driver, the driver is received in the connecting portion and coupled with the lamp holder.

15. The LED lamp of claim 14, wherein the connecting base is cone-shaped and has a bottom surface coupled with the driver and a top surface located opposite to the bottom surface, a diameter of the connecting base decreases gradually from the bottom surface to the top surface, a diameter of the bottom surface is larger than that of the top surface.

16. The LED lamp of claim 15, wherein the bottom surface is coupled with the driver and the top surface is coupled with the wire frame and the filaments.

17. The LED lamp of claim 16, wherein the filaments are coupled with the lamp holder by the connecting base and the driver.

18. The LED lamp of claim 1, wherein the connecting base, the supporting pillar, the wire frames and the filaments are received in the first cavity therein.

19. The LED lamp of claim 1, wherein the lampshade and the connecting portion define a vacuum sealed cavity, the vacuum sealed cavity is filled with thermal conductive gap for heat dissipation.
